(19) United States
(12) Patent Application Publication
(10) Pub. No.: US 2025/0320697 A1
(43) Pub. Date: Oct. 16, 2025

(54) DEVICE FOR EXTRACTING WATER FROM AMBIENT AIR

(71) Applicant: CESKE VYSOKE UCENI TECHNICKE V PRAZE, 1600 00 Praha 6 (CZ)

(72) Inventors: Vladimír SULC, Bustehrad (CZ); Tomas MATUSKA, Praha 4- Michle (CZ); Vladimir ZMRHAL, Odolena Voda (CZ)

(73) Assignee: CESKE VYSOKE UCENI TECHNICKE V PRAZE, 160 00 Praha 6 (CZ)

(21) Appl. No.: 19/176,265

(22) Filed: Apr. 11, 2025

(30) Foreign Application Priority Data
Apr. 12, 2024 (CZ) PV 2024-138

(51) Int. Cl. E03B 3/28; B01D 53/06; B01D 53/26

(52) U.S. Cl. CPC E03B 3/28; B01D 53/06; B01D 53/261; B01D 53/265; B01D 2257/80; B01D 2259/4009

(57) ABSTRACT

The device for extracting water from ambient air comprises a regeneration air duct, a cooled regeneration air duct, and a process air duct. The device includes heat exchangers: a main air heater, a main superheated refrigerant vapor condenser, a primary refrigerant evaporator, a liquid refrigerant subcooler, an additional refrigerant evaporator, an auxiliary air heater, and an auxiliary superheated refrigerant vapor condenser, all of which are connected to a closed refrigerant circuit with a compressor. The device further comprises a sorption heat exchanger and other components. The main air heater, the main superheated refrigerant vapor condenser, the auxiliary air heater, and the auxiliary superheated refrigerant vapor condenser are divided into sections closable by controlled valves and for regulating the transferred thermal output and achieving the desired air temperature before the sorption heat exchanger.

### FIELD OF THE INVENTION

The invention relates to a device that enables the extraction of water from ambient air by means of sorption and desorption for the dehumidification of the process air stream and the humidification of the regeneration air stream. The transfer of heat between different parts of the device, carried out via a refrigerant circuit, allows for the extraction of more water with lower energy consumption than conventional condensation devices and sorption devices. The device is intended for operation across a wide range of variable air temperature and humidity conditions. An imbalance between the supply and removal of heat from the regeneration air is addressed by a modular arrangement of heat exchangers into sections and by controlled heat exchange between parts of the device.

### BACKGROUND OF THE INVENTION

In the field of water extraction from air, there are various devices available on the market that operate on the principle of cooling ambient air using a heat exchanger with a temperature lower than the dew point, at which water vapor from the air condenses on its surface in the form of water droplets. The disadvantage of such a solution is that in the case of low specific humidity of ambient air below 5 g/kg of dry air, the water output is very low and at the same time energy-intensive. For water extraction from ambient air in dry regions, devices based on the sorption of moisture into a sorption material have therefore been developed.

The device according to patent U.S. Pat. No. 7,043,934B2 for extracting water from air uses a sorption system to remove moisture from cold and dry outdoor air, followed by a cooling device (compressor or absorption type) for condensing the moisture into liquid water. For the regeneration of the sorption heat exchanger, it mentions various heat sources ranging from waste heat from exhaust gases to heat from solar collectors. Photovoltaic cells can be used as the source of electrical energy for operation. The disadvantage lies in the high energy consumption, since heat recovery from cooling is not utilized.

The device according to patent US2006/0272344A1 uses a sorption system based on a sorption wheel with a solid desiccant and a closed regeneration circuit. Waste heat from the combustion engine of a mobile device is used for regenerating the desiccant. The dehumidified process air exiting the sorption wheel serves as a source of cooling for the condensation heat exchanger, where water vapor is condensed from the humid and warm air. The disadvantage of such a device is that it can operate only in cold or humid areas, so that the temperature of the dehumidified process air is sufficiently below the dew point temperature of the humid air, enabling condensation of water in the cooler.

The device according to patent U.S. Pat. No. 7,601,208 uses a desiccant system based on a liquid desiccant, which absorbs moisture from the air by spraying. Water is subsequently expelled from the desiccant solution using waste heat from the combustion engine of a mobile device. Water vapor condenses in a cooler, where the source of cooling is the drawn-in outdoor air. The disadvantage of such a device is that it can operate only in cold or humid areas, so that the temperature of the ambient air is sufficiently below the dew point temperature of the humid air, enabling condensation of water in the cooler.

The device according to patent US2011/0296858 uses a desiccant system with a sorption wheel containing a solid desiccant. Outdoor air passes through the sorption wheel, and part of the water vapor content is adsorbed on the desiccant surface. The dehumidified air is subsequently heated in a microwave chamber to a high temperature and directed back to a part of the sorption wheel for its regeneration. The heated air reabsorbs moisture from the desiccant surface and enters the cooler, where the water vapor condenses. The benefit is unclear from the schematic, as the device operates with a constant flow rate of process air and regeneration air, and the moisture content in the air is not increased before condensation.

The device for extracting water from ambient air according to patent U.S. Pat. No. 11,065,573-B2 enables water extraction from air in dry and hot climatic regions, wherein the operation of this device may, in a specific embodiment, be autonomous with energy supplied from local renewable sources. The disadvantage of the device is the water circuit for precooling and the low ability to regulate performance under variable air temperature and humidity.

The disadvantage of the mentioned solutions is the limited range of use, either in areas with high humidity or low ambient air temperature, or conversely only in dry and hot regions such as deserts. None of the devices is universal with the capability of operating across a very wide range of ambient air temperatures and humidity levels.

### SUMMARY OF THE INVENTION

The above-mentioned disadvantages are eliminated by the device for extracting water from ambient air according to the present invention, which enables efficient extraction of water from air across a wide range of air temperatures and humidity levels, while also allowing the control of heat flows between individual parts of the device under changing operating conditions during the day and throughout the year. This makes it possible to extract more water from ambient air with low energy consumption throughout the year in various environments and climatic conditions.

The device for extracting water from ambient air according to this invention comprises a first regeneration air duct, a second cooled regeneration air duct, and a third process air duct. The first regeneration air duct has a first inlet opening for regeneration air, and the third process air duct has a second inlet opening for process air. The inlet openings are connected to the ambient environment. The first regeneration air duct is connected to the second cooled regeneration air duct by a first connecting opening. The second cooled regeneration air duct is connected to the third process air duct by a second connecting opening. The device further comprises a sorption heat exchanger, which is movable such that at least part of its volume is transferable between all three air ducts, wherein a space for the placement of this sorption heat exchanger is reserved in each of the air ducts. A first suction device is placed in the first regeneration air duct, and a second suction device is placed in the third process air duct. A main air heater for heating the regeneration air and a primary air cooler with a surface temperature below the dew point temperature for cooling the regeneration air are also arranged in the first regeneration air duct, such that the space for the placement of the sorption heat exchanger is located between the main air heater and the primary air cooler. The first suction device is placed anywhere in the first regeneration air duct such that it draws air in the direction from the main air heater toward the primary air cooler. The device comprises a water collection element for collecting water condensed from the regeneration air, which is located below the primary air cooler. The device also comprises a closed refrigerant circuit including a refrigerant and refrigerant piping.

The essence of this device is that the refrigerant circuit includes a compressor for drawing in and compressing vaporized refrigerant, which is connected to two branches. In the main branch, the compressor is connected via the main shut-off valve assembly to the main superheated refrigerant vapor condenser and to a condenser for condensing refrigerant vapor, which is the main air heater. In the auxiliary branch, the compressor is connected via an auxiliary shut-off valve assembly to an auxiliary superheated refrigerant vapor condenser and to a condenser for condensing refrigerant vapor, which is the auxiliary air heater. Condensed liquid refrigerant from both branches flows into a liquid refrigerant collector, which is connected in the primary branch via a primary controlled shut-off valve to a liquid refrigerant subcooler, a primary expansion valve, and an evaporator for vaporizing the refrigerant, which is the primary air cooler. In the additional branch, the liquid refrigerant collector is connected via an additional controlled shut-off valve to an additional expansion valve and an evaporator for vaporizing the refrigerant, which is the additional air cooler.

It is preferred that the main superheated refrigerant vapor condenser and the main air heater are structurally composed of at least two sections, each closable by a valve assembly with controlled valves, and that the auxiliary superheated refrigerant vapor condenser and the auxiliary air heater are also structurally composed of at least two sections, each closable by a valve assembly with controlled valves.

It is preferred that the primary air cooler and the additional air cooler are also divided into at least two individually closable sections.

It is preferred that the air coolers are constructed as parallel-flow heat exchangers.

In a preferred embodiment, the main air heater, the main superheated refrigerant vapor condenser, the main backup air heater, the sorption heat exchanger, the primary air cooler, and the liquid refrigerant subcooler are arranged in sequence in the first regeneration air duct from the inlet opening toward the connecting opening with the cooled regeneration air duct.

In a preferred embodiment, the auxiliary backup air heater, the additional air cooler, and the sorption heat exchanger are arranged in sequence in the second cooled regeneration air duct from the first connecting opening with the first regeneration air duct toward the second connecting opening with the third process air duct.

In a preferred embodiment, the sorption heat exchanger, the auxiliary air heater, and the auxiliary superheated refrigerant vapor condenser are arranged in sequence in the third process air duct from the second inlet opening for process air toward the outlet opening for process air.

It is preferred that the sorption heat exchanger is rotary.

In a preferred embodiment, the backup air heaters are electric.

### BRIEF DESCRIPTION OF THE DRAWINGS

The invention will be explained in more detail with the aid of drawings, wherein:

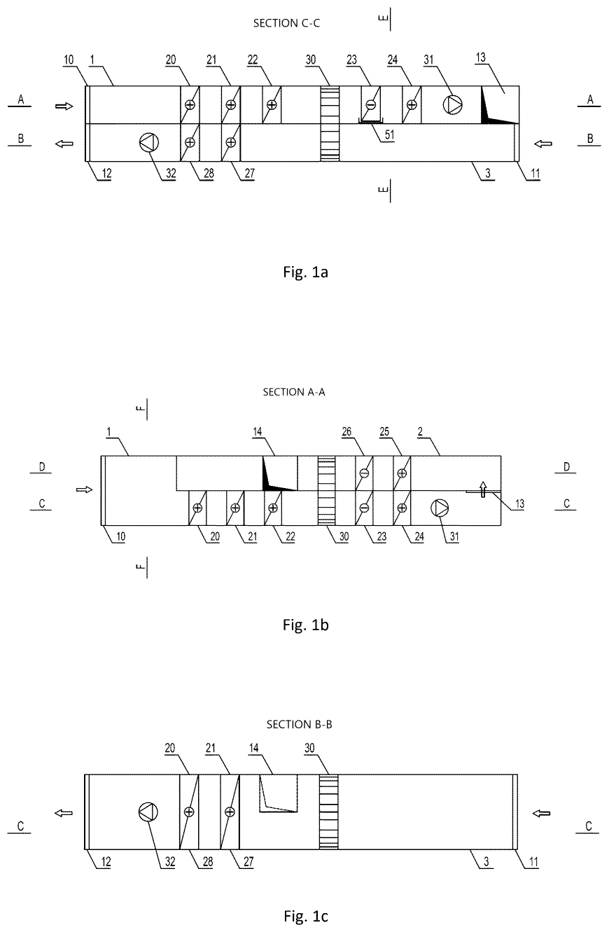

in FIGS. 1a, 1b, and 1c, schematic longitudinal sections of the device are shown;

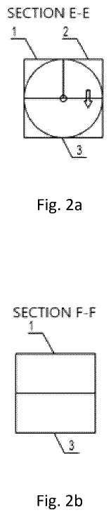

in FIGS. 2a and 2b, schematic cross sections of the device are shown;

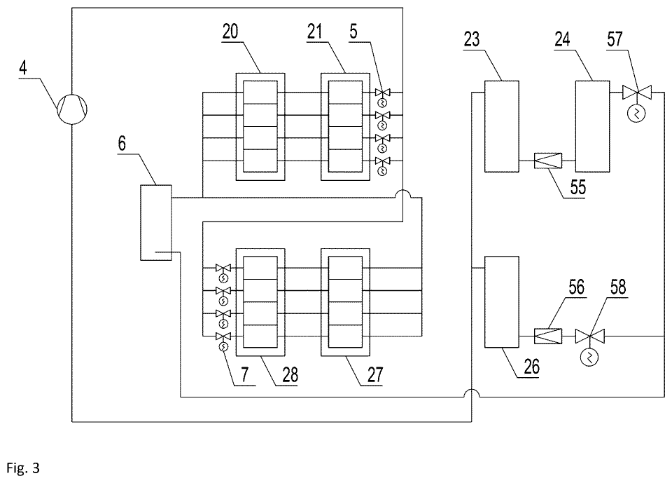

in FIG. 3, the refrigerant circuit of the device is shown schematically.

### EXEMPLARY EMBODIMENTS OF THE INVENTION

In FIGS. 1a, 1b, and 1c, schematic longitudinal sections of the device are shown, in which three air ducts are visible: the first regeneration air duct 1, the second cooled regeneration air duct 2, and the third process air duct 3. The air ducts are functionally interconnected at certain points of the device. The size and mutual dimensional proportions of the flow cross-sections of the air channels do not necessarily correspond precisely to the sections E-E and F-F shown in FIGS. 2a and 2b. The sections are illustrative only, and the correct dimensions and mutual size ratios of the individual channels are determined based on calculations. The device further comprises heat exchangers (20, 21, 23, 24, 26, 27, 28) connected to a closed refrigerant circuit with a compressor 4, a sorption heat exchanger 30, which is a circular rotary adsorption regeneration heat exchanger, and other components.

Regeneration air enters the device through the first inlet opening 10, see FIGS. 1a and 1c. The air stream in the first regeneration air duct 1 is gradually heated by heat exchangers arranged in series. In the direction of the air flow, the heat exchangers are arranged in the following order: the main air heater 20, which is a refrigerant condenser, and the main superheated refrigerant vapor condenser 21. Both heat exchangers are divided into individually closable modules for performance control. If the minimum required air temperature is not achieved at the outlet of the main superheated refrigerant vapor condenser 21, the regeneration air stream can be further heated by the main backup air heater 22. If the outlet air temperature exceeds the maximum allowed value, the control system closes a corresponding number of sections of the main superheated refrigerant vapor condenser 21 and the main air heater 20, and the refrigerant flow is redirected to the sections of auxiliary heat exchangers: the auxiliary superheated refrigerant vapor condenser 28 and the auxiliary air heater 27, which is a refrigerant condenser, both located in the third process air duct 3, where the excess heat is transferred to the outgoing process air stream.

The heated regeneration air stream enters the sorption heat exchanger 30, whose temperature is significantly lower, and extracts bound moisture from the adsorption material applied to the surface of the sorption heat exchanger 30. This process results in the drying of the sorption heat exchanger 30 while simultaneously cooling the regeneration air stream. The pre-cooled regeneration air stream then flows through the primary air cooler 23, which is a refrigerant evaporator with a surface temperature below the dew point temperature of the regeneration air. This realizes the function of the entire device—the moisture contained in the regeneration air stream condenses. Condensed water is collected in the water collection element 51. At the same time, the regeneration air is cooled. The dried and cooled regeneration air stream continues through the liquid refrigerant subcooler 24, where it is heated. The regeneration air stream is drawn in by the first suction device 31 and enters the second cooled regeneration air duct 2 through the first connecting opening 13, where the auxiliary backup air heater 25 and the additional air cooler 26, which is a refrigerant evaporator, are located. If the temperature of the regeneration air stream at the outlet of the additional air cooler 26 in the second cooled regeneration air duct 2 is lower than 0° C., the air stream is preheated by the auxiliary backup air heater 25. From the additional air cooler 26, the cooled regeneration air stream flows through the second cooled regeneration air duct 2 into a defined section of the sorption heat exchanger 30, wherein it cools this part of the sorption heat exchanger 30. By cooling the surface of the sorption heat exchanger 30, the moisture-binding capacity of the exchanger surface material from the process air is increased.

The process air stream is drawn in from the ambient environment through the second inlet opening 11 and flows through the third process air duct 3 into the pre-cooled section of the sorption heat exchanger 30. The rotation direction of the sorption heat exchanger 30 is indicated in FIG. 2a. Here, the air moisture contained in the process air stream, which has a higher temperature than the pre-cooled section of the sorption heat exchanger 30, binds to the surface of the adsorption material of the exchanger. After the sorption heat exchanger 30, the regeneration air stream and the process air stream are mixed. The regeneration air is brought from the second cooled regeneration air duct 2 into the third process air duct 3 through the second connecting opening 14. The mixture of both air streams then passes through the auxiliary air heater 27 and the auxiliary superheated refrigerant vapor condenser 28 and is heated. The air stream from the third process air duct 3 exits the device through the outlet opening 12. The transport of process air in the third process air duct 3 is ensured by the second suction device 32.

The refrigerant circuit of the device is shown in FIG. 3 and consists of the following components. In the direction of refrigerant flow, the main branch includes the compressor 4, the modular main superheated refrigerant vapor condenser 21 with individual sections closable by the main shut-off valve assembly 5, the modular main air heater 20, which serves as a refrigerant condenser, the liquid refrigerant collector 6, the primary controlled shut-off valve 57, the liquid refrigerant subcooler 24, the primary expansion valve 55, and the primary air cooler 23, which functions as a refrigerant evaporator. A parallel branch to the one with the main superheated refrigerant vapor condenser 21 and the main air heater 20 includes the modular auxiliary superheated refrigerant vapor condenser 28 with individual sections closable by the auxiliary shut-off valve assembly 7, and the modular auxiliary air heater 27, which serves as the auxiliary refrigerant condenser. A parallel branch to the one with the primary air cooler 23 includes the additional air cooler 26, connected via the additional controlled shut-off valve 58 and the additional expansion valve 56.

The division of heat exchangers 20, 21, 27, and 28 into individual sections is intended to achieve the desired temperature of the flowing regeneration air at the inlet to the defined section of the sorption heat exchanger 30 in the first regeneration air duct 1 under various climatic conditions (temperature and humidity of ambient air). In the first regeneration air duct 1, only as much heat from superheated vapor and refrigerant condensation is used as is needed to heat the flowing regeneration air to the required temperature, which means that certain sections of the heat exchangers 20 and 21 in the first regeneration air duct 1 may be disconnected by the main shut-off valve assembly 5. The remaining portion of the heat is thus transferred in the sections of heat exchangers 27 and 28 located in the third process air duct 3 into the process air stream before it exits the device.

The primary air cooler 23 is placed downstream of the sorption heat exchanger 30, in the section from which heated and moisture-enriched regeneration air flows. The additional air cooler 26 is located at the inlet to the sorption heat exchanger 30 in the second cooled regeneration air duct 2, and its dimensions define the size of the cooled section of the sorption heat exchanger 30. This section is cooled before coming into contact with the process air stream.

Both air coolers 23 and 26 are constructed as parallel-flow units, which allows, with proper adjustment of refrigerant superheat, compressor speed, and other control parameters, to ensure that the air temperature at the outlets of both coolers does not drop below the freezing point.

Downstream of the primary air cooler 23, in the direction of the regeneration air flow, the liquid refrigerant subcooler 24 is arranged. The cooled regeneration air exiting the primary air cooler 23 enables subcooling of the liquid refrigerant in the subcooler 24 before it enters the primary expansion valve 55. Due to variable operating conditions, the refrigerant circuit is equipped with a liquid refrigerant collector 6, from which, when properly filled, only saturated liquid refrigerant exits. By increasing the temperature of the regeneration air through heating in the subcooler 24, it is also ensured that the air temperature at the outlet of the additional air cooler 26 does not drop below the freezing point. However, if under certain operating conditions the air temperature is still at risk of dropping below freezing, the air stream can be preheated by the auxiliary backup air heater 25. The inclusion of the liquid refrigerant subcooler 24 in the refrigerant circuit also results in increased energy efficiency of the entire device.

### INDUSTRIAL APPLICABILITY

The device according to the present invention can be used for extracting liquid water from air across a wide range of variable temperature and humidity conditions, both in environments with high ambient air temperatures and humidity levels and in environments with low ambient air temperatures and humidity levels. The device enables higher water production from air than conventional condensation devices operating on the simple cooling of air below the dew point temperature. The device also enables lower electrical energy consumption for extracting water from air compared to conventional sorption devices.

### REFERENCE SIGNS LIST

1—First regeneration air duct
2—Second cooled regeneration air duct
3—Third process air duct
4—Compressor
5—Main shut-off valve assembly
6—Liquid refrigerant collector
7—Auxiliary shut-off valve assembly
10—First inlet opening
11—Second inlet opening
12—Outlet opening
13—First connecting opening
14—Second connecting opening
20—Main air heater
21—Main superheated refrigerant vapor condenser
22—Main backup air heater
23—Primary air cooler
24—Liquid refrigerant subcooler
25—Auxiliary backup air heater
26—Additional air cooler
27—Auxiliary air heater
28—Auxiliary superheated refrigerant vapor condenser
30—Sorption heat exchanger
31—First suction device
32—Second suction device
51—Water collection element
55—Primary expansion valve
56—Additional expansion valve
57—Primary controlled shut-off valve
58—Additional controlled shut-off valve

1. A device for extracting water from ambient air, comprising a first regeneration air duct and a third process air duct, wherein the first regeneration air duct has a first inlet opening) for regeneration air and the third process air duct has a second inlet opening for process air, and both air ducts are connected via a second cooled regeneration air duct with an outlet opening through a second connecting opening, wherein the openings are connected to the ambient environment, and further wherein the first regeneration air duct is connected to the second cooled regeneration air duct by a first connecting opening, and the device further comprises a movable sorption heat exchanger that is at least partially transferable between the air ducts, wherein a first suction device is located in the first regeneration air duct and a second suction device is located in the third process air duct, wherein the first regeneration air duct further comprises a main air heater for heating the regeneration air and a primary air cooler with a surface temperature below the dew point temperature for cooling the regeneration air, such that a space for placing the sorption heat exchanger is located between the main air heater and the primary air cooler, and the first suction device is located in the first regeneration air duct for drawing air in the direction from the main air heater toward the primary air cooler, wherein the device comprises a first water collection element for collecting water condensed from the regeneration air and further comprises a closed refrigerant circuit including a refrigerant and refrigerant piping, wherein the refrigerant circuit comprises a compressor for drawing in and compressing vaporized refrigerant, which is connected to a main shut-off valve assembly, a main superheated refrigerant vapor condenser, and a condenser for condensing refrigerant vapor, which is the main air heater, and further wherein the compressor is connected to an auxiliary shut-off valve assembly, an auxiliary superheated refrigerant vapor condenser, and a condenser for condensing refrigerant vapor, which is the auxiliary air heater, wherein the condensed liquid refrigerant is directed into a liquid refrigerant collector, which is connected to a primary controlled shut-off valve, a liquid refrigerant subcooler, a primary expansion valve, and an evaporator for vaporizing the refrigerant, which is the primary air cooler, and is further connected to an additional controlled shut-off valve, an additional expansion valve, and an evaporator for vaporizing the refrigerant, which is the additional air cooler.

2. The device for extracting water from ambient air according to claim 1, wherein the main superheated refrigerant vapor condenser and the main air heater are structurally composed of at least two sections of the main shut-off valve assembly, and the auxiliary superheated refrigerant vapor condenser and the auxiliary air heater are structurally composed of at least two auxiliary shut-off valve assemblies.

3. The device for extracting water from ambient air according to claim 2, wherein the primary air cooler and the additional air cooler are divided into at least two individually closable sections.

4. The device for extracting water from ambient air according to claim 3, wherein the main superheated refrigerant vapor condenser and the primary air cooler are constructed as parallel-flow heat exchangers.

5. The device for extracting water from ambient air according to claim 2, wherein in the first regeneration air duct, the main air heater, the main superheated refrigerant vapor condenser, the main backup air heater, the sorption heat exchanger, the primary air cooler, and the liquid refrigerant subcooler are arranged in sequence from the first inlet opening toward the first connecting opening.

6. The device for extracting water from ambient air according to claim 4, wherein in the second cooled regeneration air duct, the auxiliary backup air heater, the additional air cooler, and the sorption heat exchanger are arranged in sequence from the first connecting opening toward the second connecting opening.

7. The device for extracting water from ambient air according to claim 5, wherein in the third process air duct, the sorption heat exchanger, the auxiliary air heater, and the auxiliary superheated refrigerant vapor condenser are arranged in sequence from the second inlet opening toward the outlet opening.

8. The device for extracting water from ambient air according to claim 1, wherein the sorption heat exchanger is rotary.

9. The device for extracting water from ambient air according to claim 1, wherein the main backup air heater and the auxiliary backup air heater are electric air heaters.
